(19) United States
(12) Patent Application Publication
(10) Pub. No.: US 2012/0064795 A1
(43) Pub. Date: Mar. 15, 2012

(54) PROCESS FOR PRODUCTION OF PLASMA DISPLAY PANEL

(76) Inventors: Hideji Kawarazaki, Osaka (JP); Keiji Horikawa, Osaka (JP); Chiharu Koshio, Kyoto (JP); Kanako Okumura, Osaka (JP)

(21) Appl. No.: 13/320,678

(22) PCT Filed: Feb. 8, 2011
(86) PCT No.: PCT/JP2011/000678

§ 371 Date: Nov. 15, 2011

(30) Foreign Application Priority Data
Feb. 12, 2010 (JP) 2010-028461
Feb. 12, 2010 (JP) 2010-028462

(51) Int. Cl. H01J 9/38

(52) U.S. Cl. 445/56

(57) ABSTRACT

Disclosed is a method of manufacturing a plasma display panel having a discharge space and a protection layer facing the discharge space. The protection layer is exposed to the reducing organic gas by introducing gases containing the reducing organic gas into the discharge space. Then, the reducing organic gas is exhausted from the discharge space. Then, the discharge gas is hermetically enclosed in the discharge space.

### TECHNICAL FIELD

Techniques disclosed herein relate to a method of manufacturing a plasma display panel used in a display device and the like.

### BACKGROUND ART

A plasma display panel (hereinafter, referred to as a PDP) includes front and rear panels. The front panel includes a glass substrate, a display electrode on a main surface at one side of the glass substrate, a dielectric layer that covers the display electrode and serves as a condenser, and a protection layer made of magnesium oxide (MgO) and formed on the dielectric layer. Meanwhile, the rear panel includes a glass substrate, a data electrode formed on a main surface at one side of the glass substrate, an insulating layer that covers the data electrode, barrier ribs formed on the insulating layer, and phosphor layers that are formed in each gap between the barrier ribs and emit light of red, green, and blue colors.

The protection layer principally has two functions. A first function is to protect the dielectric layer from ion bombardment caused by electric discharge. A second function is to discharge initial electrons for generating address discharge. Since the dielectric layer is protected from the ion bombardment, rising of the discharge voltage is suppressed. Since the number of discharged initial electrons increases, the address discharge errors that may cause image flickering are reduced. In order to increase the number of discharged initial electrons, there is known a technique of adding impurities to MgO and a technique of forming MgO particles on the MgO film (for example, refer to PTL 1, 2, 3, 4, and 5).

### CITATION LIST

### Patent Literature

PTL1 Unexamined Japanese Patent Publication No. 2002-260535
PTL 2 Unexamined Japanese Patent Publication No. 11-339665
PTL 3 Unexamined Japanese Patent Publication No. 2006-59779
PTL 4 Unexamined Japanese Patent Publication No. 8-236028
PTL 5 Unexamined Japanese Patent Publication No. 10-334809

### SUMMARY OF THE INVENTION

There is provided a method of manufacturing a PDP including a discharge space and a protection layer facing the discharge space. The protection layer is exposed to the reducing organic gas by introducing gases containing a reducing organic gas into the discharge space. Then, the reducing organic gas is exhausted from the discharge space. Then, the discharge gas is hermetically sealed in the discharge space.

### BRIEF DESCRIPTION OF THE DRAWINGS

FIG. 1 is a perspective view illustrating a structure of the PDP according to an embodiment of the invention.

FIG. 2 is an electrode arrangement diagram of the PDP according to an embodiment of the invention.

FIG. 3 is a block circuit diagram illustrating a plasma display apparatus according to an embodiment of the invention.

FIG. 4 is a waveform diagram of a drive voltage of the plasma display apparatus according to an embodiment of the invention.

FIG. 5 is a flowchart illustrating an exemplary method of manufacturing the PDP according to an embodiment of the invention.

FIG. 6 is a diagram illustrating an example of a first temperature profile.

FIG. 7 is a diagram illustrating an example of a second temperature profile.

FIG. 8 is a diagram illustrating an example of a third temperature profile.

FIG. 9 is a schematic diagram illustrating a cross section of the PDP according to an embodiment of the invention.

FIG. 10 is a diagram illustrating an electron emission characteristic and a Vscn lighting-on voltage.

### DESCRIPTION OF EMBODIMENTS

### 1. Structure of PDP1

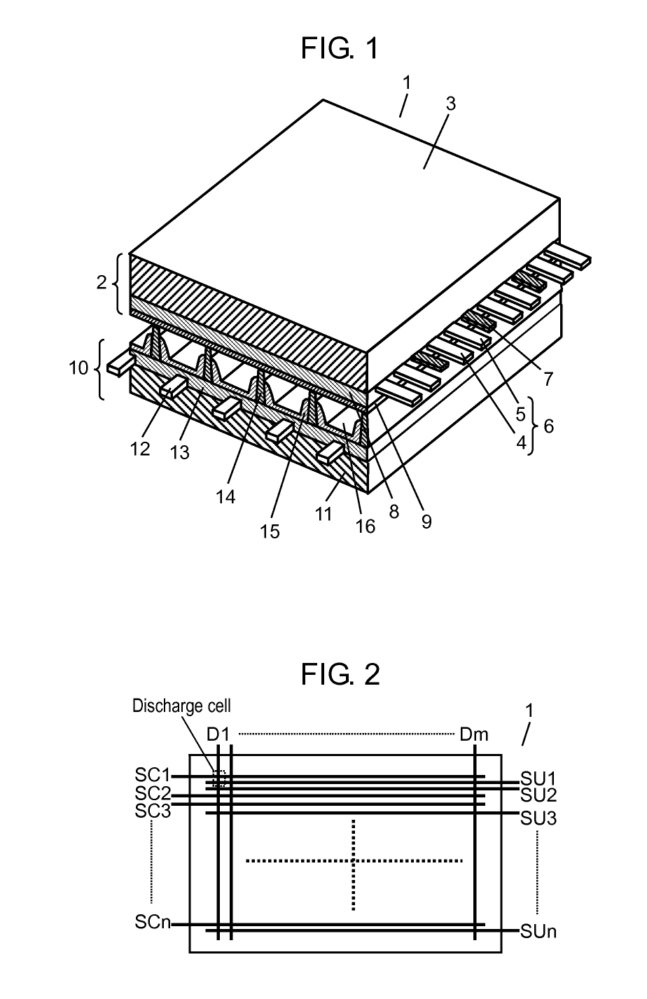

A basic structure of PDP is a typical AC surface-discharge type PDP. As shown in FIG. 1, PDP 1 includes front panel 2 made from front glass substrate 3 and the like and rear panel 10 made from rear glass substrate 11 and the like arranged to face each other. Front and rear panels 2 and 10 are hermetically sealed by an encapsulating material having an outer circumferential portion made of glass frit and the like. Discharge gases, such as neon (Ne) and xenon (Xe), are enclosed in discharge space 16 inside the sealed PDP 1 under a pressure of 53 kPa (400 Torr) to 80 kPa (600 Torr).

On front glass substrate 3, a plurality of pairs of band-like display electrodes 6 including scan and sustain electrodes 4 and 5 and a plurality of black stripes 7 are arranged in parallel to each other. On front glass substrate 3, dielectric layer 8 serving as a condenser is formed to cover display electrode 6 and black stripe 7. In addition, protection layer 9 made of magnesium oxide (MgO) and the like is formed on the surface of dielectric layer 8. In addition, protection layer 9 will be described below in detail.

In each of scan electrode 4 and sustain electrode 5, a bus electrode made of Ag is stacked on the transparent electrode made of conductive metal oxide such as indium tin oxide (ITO), tin oxide (SnO₂), and zinc oxide (ZnO).

On rear glass substrate 11, a plurality of data electrodes 12 made of a conductive material containing silver Ag as a main component are arranged in parallel to each other in a direction perpendicular to the display electrode 6. Data electrode 12 is covered by insulating layer 13. On insulating layer 13 between data electrodes 12, barrier rib 14 having a predetermined height to compartmentalize discharge space 16 is provided. In the trenches between barrier ribs 14, phosphor layer 15 emitting red light, phosphor layer 15 emitting green light, and phosphor layer 15 emitting blue light by ultraviolet rays are sequentially coated and formed for each data electrode 12. A discharge cell is formed in the position where display electrode 6 and data electrode 12 intersect with each other. The discharge cell having red, green, and blue phosphor layers 15 arranged line by line in the direction of display electrode 6 corresponds to a pixel for color display.

In addition, according to the present embodiment, the discharge gas enclosed in the discharge space 16 contains Xe to be equal to or larger than 10 volume % and equal to or smaller than 30 volume %.

As shown in FIG. 2, PDP 1 has n scan electrodes SC1, SC2, SC3 . . . and SCn (four in FIG. 1) arranged to extend in the row direction. PDP 1 also has n sustain electrodes SU1, SU2, SU3 . . . and SUn (five in FIG. 1) arranged to extend in the row direction. PDP 1 has m data electrodes D1 . . . Dm (twelve in FIG. 1) arranged to extend in the column direction. In addition, a discharge cell is formed at portions where a pair of a scan electrode SC1 and a sustain electrode SU1, and a data electrode D1 intersect with one another. A number of discharge cells (=m×n) are formed in the discharge space. The scan electrodes and sustain electrodes are connected to connectors provided in peripheral ends beside the image display area of the front panel. The data electrodes are connected to connectors provided peripheral ends beside the image display area of the rear panel.

### 2. Structure of Plasma Display Apparatus

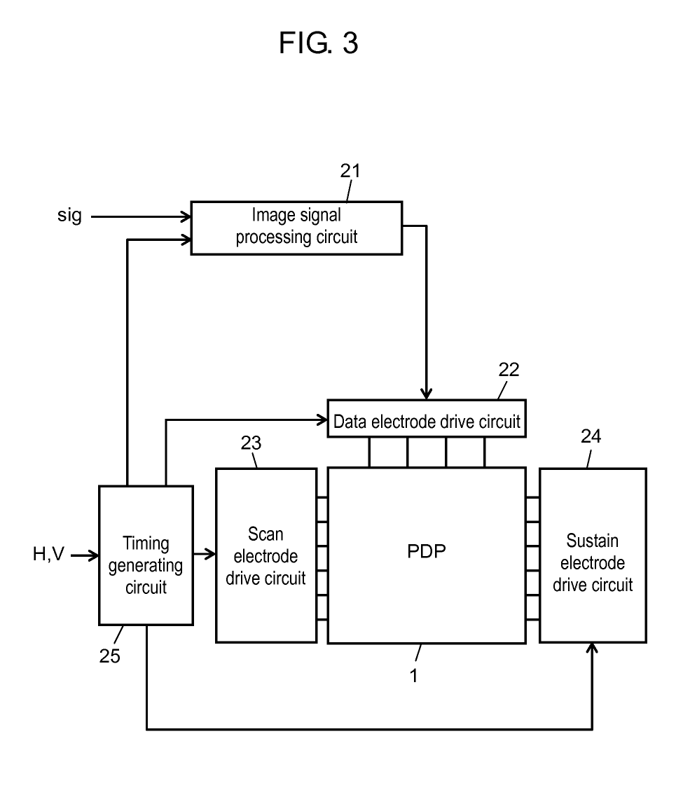

As shown in FIG. 3, the plasma display apparatus includes PDP 1, image signal processing circuit 21, data electrode drive circuit 22, scan electrode drive circuit 23, sustain electrode drive circuit 24, timing generator circuit 25, and power circuit (not shown).

Image signal processing circuit 21 converts the image signal sig to image data of each subfield. Data electrode drive circuit 22 converts the image data of each subfield into signals corresponding to each data electrodes D1 to Dm to drive each data electrode D1 to Dm. Timing generator circuit 25 generates various timing signals based on the horizontal synchronizing signal H and the vertical synchronizing signal V and supplies them to each drive circuit. Scan electrode drive circuit 23 supplies the drive voltage waveform to the scan electrodes SC1 to SCn based on the timing signal. Sustain electrode drive circuit 24 supplies the drive voltage waveform to sustain electrodes SU1 to SUn based on the timing signal.

### 3. Driving of PDP 1

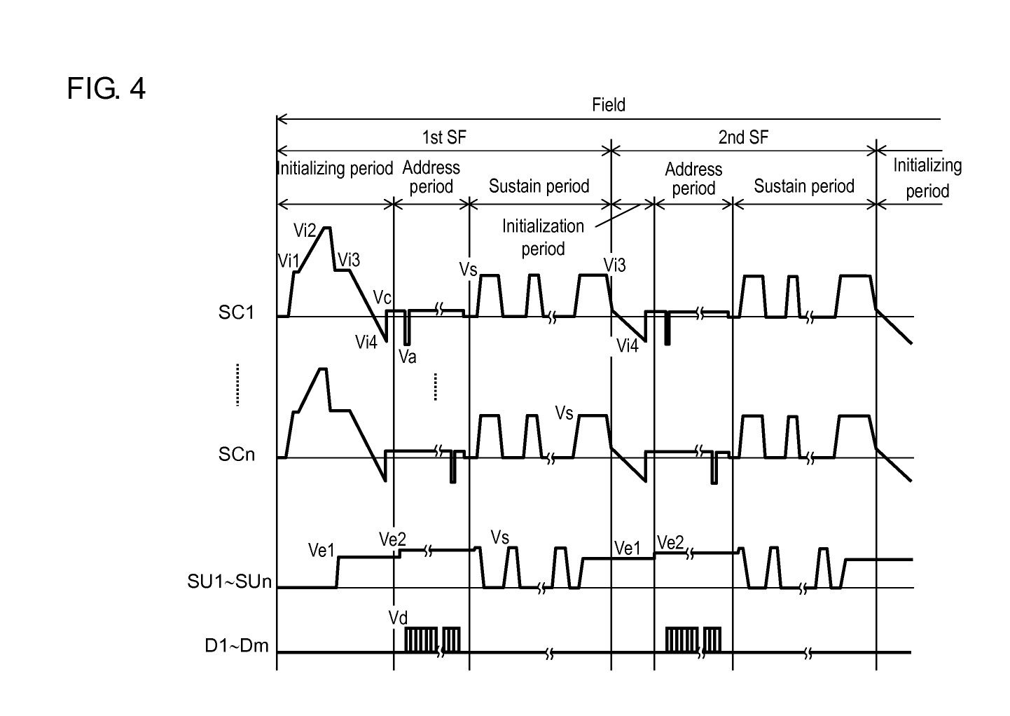

As shown in FIG. 4, the plasma display apparatus includes a plurality of subfields in a single field. The subfield has an initializing period, an address period, and a sustain period. The initialization period is a period for generating initializing discharge for the discharge cell. The address period is a period for generating address discharge to select the discharge cell emitting light after the initializing period. The sustain period is a period for generating sustain discharge in the discharge cell selected in the address period.

3-1. Initialization Period

During the initializing period of the first subfield, data electrodes D1 to Dm and sustain electrodes SU1 to SUn are maintained at 0 V. To the scan electrodes SC1 to SCn, a ramp voltage gradually rising from voltage Vi1(V) equal to or smaller than the discharge initiation voltage to voltage Vi2(V) exceeding the discharge initiation voltage is applied. Then, a first weak initialization discharge is generated in all of the discharge cells. By the initialization discharge, a negative wall voltage is accumulated in scan electrodes SC1 to SCn. The positive wall voltage is accumulated in sustain electrodes SU1 to SUn and data electrodes D1 to Dm. The wall voltage is a voltage generated by wall charge accumulated in protection layer 9, phosphor layer 15, or the like.

Subsequently, sustain electrodes SU1 to SUn are maintained at positive voltage Ve1(V), and a ramp voltage gradually falling from voltage Vi3(V) to voltage Vi4(V) is applied to scan electrodes SC1 to SCn. Then, a second weak initializing discharge is generated in all of the discharge cells. The all voltage between scan electrodes SC1 to SCn and sustain electrodes SU1 to Sun is weakened. The wall voltage in data electrodes D1 to Dm is adjusted to a suitable value in the address operation.

3-2. Address Period

In the subsequent address period, first, scan electrodes SC1 to SCn are maintained at voltage Vc(V). The sustain electrodes SU1 to SUn are maintained at voltage Ve2(V). Then, negative scan pulse voltage Va(V) is applied to the first row of scan electrode SC1, and positive address pulse voltage Vd(V) is applied to data electrodes Dk(k=1 to m) of the discharge cell to be displayed for the first row of data electrodes D1 to Dm. In this case, a voltage at the intersection between data electrode Dk and scan electrode SC1 is obtained by adding the wall voltage of the data electrode Dk and the wall voltage of the scan electrode SC1 to external voltage (Vd-Va)(V), thus exceeding the discharge initiation voltage. In addition, the address discharge is generated between data electrode Dk and scan electrode SC1 and between sustain electrode SU1 and scan electrode SC1. The positive wall voltage is accumulated in scan electrode SC1 of the discharge cell at which the address discharge has been generated. A negative wall voltage is accumulated in sustain electrode SU1 of the discharge cell at which the address discharge has been generated. A negative wall voltage is accumulated in data electrode Dk of the discharge cell at which the address discharge has been generated.

Meanwhile, a voltage at the intersection between data electrodes D1 to Dm and scan electrode SC1 to which address pulse voltage Vd(V) has not been applied does not exceed the discharge initiation voltage. Therefore, the address discharge is not generated. The aforementioned address operation is carried out sequentially until the n-th discharge cell. The address period is terminated when the address operation of the discharge cell of the n-th row is ended.

3-3. Sustain Period

In the subsequent sustain period, positive sustain pulse voltage Vs(V) as a first voltage is applied to scan electrodes SC1 to SCn. A ground voltage, that is, 0 V as a second voltage is applied to sustain electrodes SU1 to SUn. In this case, in the discharge cell where the address discharge has been generated, the voltage between scan electrode SCi and sustain electrode SUi becomes a value obtained by adding the wall voltage of the scan electrode SCi and the wall voltage of sustain electrode SUi to sustain pulse voltage Vs(V), thereby exceeding the discharge initiation voltage. In addition, the sustain discharge is generated between scan electrode SCi and sustain electrode SUi. The phosphor layer is excited by the ultraviolet rays generated by the sustain discharge to emit light. In addition, a negative wall voltage is accumulated in scan electrode SCi. A positive wall voltage is accumulated in sustain electrode SUi. A positive wall voltage is accumulated in the data electrode Dk.

During the address period, the sustain discharge is not generated in the discharge cell in which the address discharge has not been generated. Therefore, the wall voltage is maintained when the initializing period is terminated. Subsequently, a second voltage 0V is applied to scan electrodes SC1 to SCn. Sustain pulse voltage Vs(V) as a first voltage is applied to sustain electrodes SU1 to SUn. Then, in the discharge cell at which the sustain discharge has been generated, a voltage between sustain electrode SUi and scan electrode SCi exceeds the discharge initiation voltage. Therefore, the sustain discharge is generated again between sustain electrode SUi and scan electrode SC1. That is, a negative wall voltage is accumulated in sustain electrode SUi. A positive wall voltage is accumulated in scan electrode SCi.

Similarly, if sustain pulse voltages Vs(V) of the number corresponding to the luminance weight are alternately applied to scan electrodes SC1 to SCn and sustain electrodes SU1 to SUn, the sustain discharge is continuously generated in the discharge cell in which the address discharge has been generated during the address period. As applying a predetermined number of sustain pulse voltages Vs(V) is terminated, the sustain operation in the sustain period is terminated.

3-4. After Second Subfield

The operations of the initializing period, the address period, and the sustain period after the subsequent second subfield are similar to those of the first subfield. Therefore, description thereof will not be repeated. In the subfield subsequent to the second subfield, sustain electrodes SU1 to SUn are maintained at positive voltage Ve1(V). A ramp voltage gradually falling from voltage Vi3(V) to voltage Vi4(V) is applied to scan electrodes SC1 to SCn. As a result, it is possible to generate a weak initializing discharge only for the discharge cells in which the sustain discharge has been generated in the previous subfield. That is, in the first subfield, a total cell initializing operation for generating the initializing discharge is carried out for all of the discharge cells. After the second subfield, a selection initializing operation is carried out to selectively generate initializing discharge only in the discharge cells at which the sustain discharge has been generated in the previous subfield. In addition, according to the present embodiment, the total cell initializing operation and the selection initializing operation are separately used for the first subfield and other subfields. However, the total cell initializing operation may be performed in the initializing period in the subfields other than the first subfield. Furthermore, the total cell initializing operation may be performed once per several fields.

The operations in the address period and the sustain period are similar to those of the first subfield as described above. However, the operation in the sustain period is not necessarily similar to that of the first subfield as described above. In order to generate the sustain discharge to obtain luminance corresponding to the image signal sig, the number of sustain discharge pulses Vs(V) changes. That is, the sustain period is driven to control the luminance in each subfield.

### 4. Method of Manufacturing PDP 1

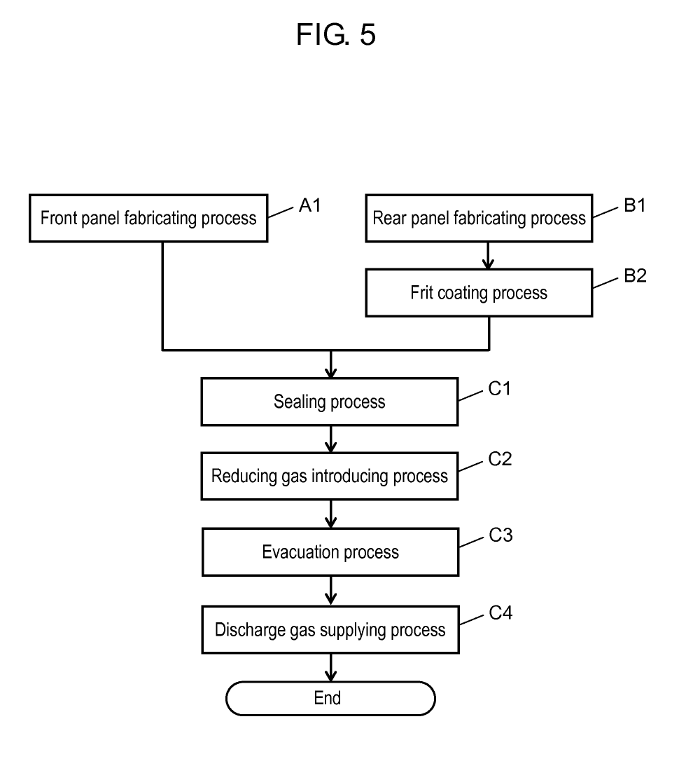

As shown in FIG. 5, a method of manufacturing the PDP 1 according to the present embodiment includes front panel fabricating process A1, rear panel fabricating process B1, frit coating process B2, sealing process C1, reducing gas introduction process C2, evacuation process C3, and discharge gas supply process C4.

4-1. Front Panel Fabricating Process A1

In front panel fabricating process A1, scan electrode 4, sustain electrode 5, and black stripe 7 are formed on front glass substrate 3 according to a photolithographic technique. Scan electrode 4 and sustain electrode 5 have metal bus electrode 4b and 5b, respectively, containing silver (Ag) for obtained conductivity. Scan electrode 4 and sustain electrode 5 also have transparent electrodes 4a and 5a, respectively. The metal bus electrode 4b is stacked on transparent electrode 4a. Metal bus electrode 5b is stacked on transparent electrode 5a.

Indium tin oxide (ITO) or the like is used in a material of transparent electrodes 4a and 5a in order to obtain transparency and conductivity as described above. First, through sputtering, the ITO thin film is formed on front glass substrate 3. Then, transparent electrodes 4a and 5a having predetermined patterns are formed using a lithographic technique.

As a material of metal bus electrodes 4b and 5b, an electrode paste containing silver (Ag), glass frit for to bind the silver, photosensitive resin, a solvent, and the like. First, through a screen print technique, the electrode paste is coated on front glass substrate 3. Then, using a drying furnace, the solvent of the electrode past is removed. Then, using a photo mask having a predetermined pattern, the electrode paste is exposed.

Then, the electrode paste is developed to form a metal bus electrode pattern. Finally, the metal bus electrode pattern is fired using a firing furnace at a predetermined temperature. That is, the photosensitive resin of the metal bus electrode pattern is removed. The glass frit of the metal bus electrode pattern is resolved. The resolved glass frit is vitrified after the firing. Through the aforementioned processes, metal bus electrodes 4b and 5b are formed.

The black stripe 7 is formed of a material containing a black pigment. Then, dielectric layer 8 is formed. As a material of dielectric layer 8, a dielectric paste containing dielectric glass frit, resin, a solvent, and the like is used. First, the dielectric paste is coated through die coating method or the like with a predetermined thickness on front glass substrate 3 to cover scan electrode 4, sustain electrode 5, and black stripe 7. Then, using the drying furnace, the solvent of the dielectric paste is removed. Finally, using the firing furnace, the dielectric paste is fired at a predetermined temperature. That is, the resin of the dielectric paste is removed. The dielectric glass frit is resolved. The resolved dielectric glass frit is vitrified after the firing. Through the aforementioned processes, dielectric layer 8 is formed. Here, in addition to a die coating method of the dielectric paste, a screen print technique, a spin coat technique, and the like may be used. In addition, without using the dielectric paste, a film of dielectric layer 8 may be formed using a chemical vapor deposition (CVD) technique and the like.

A material of dielectric layer 8 contains at least one selected from a group consisting of bismuth oxide (Bi₂O₃), calcium oxide (CaO), strontium oxide (SrO), and barium oxide (BaO) and at least one selected from a group consisting of molybdenum oxide (MoO₃), tungsten oxide (WO₃), cerium oxide (CeO₂), and manganese dioxide (MnO₂). The binder component is terpineol or butyl carbitol acetate containing ethyl cellulose or acryl resin of 1 weight % to 20 weight %. As necessary, a plasticizer such as dioctyl phthalate, dibutyl phthalate, triphenyl phosphate, or tributyl phosphate may be added to the paste, or a dispersant such as glycerol monolaurate, sorbitan sesquiolate, homogenol (Product of Kao Chemicals Co.), and alkyl aryl group ester phosphate may be added to the paste to improve a print characteristic.

Next, protection layer 9 is formed on dielectric layer 8. Details of protection layer 9 will be described below.

Through the aforementioned processes, scan electrode 4, sustain electrode 5, black stripe 7, dielectric layer 8, and protection layer 9 are formed on front glass substrate 3 to complete front panel 2.

4-2. Rear Panel Fabricating Process B1

First, through a photolithographic technique, data electrode 12 is formed on rear glass substrate 11. As a material of data electrode 12, a data electrode paste containing silver (Ag) for obtaining conductivity, glass frit to bind silver, photosensitive resin, a solvent, and the like is used. First, through a screen print technique, the data electrode paste is coated on rear glass substrate 11 with a predetermined thickness. Then, using a drying furnace, the solvent of data electrode paste is removed. Then, using a photo mask having a predetermined pattern, the data electrode paste is exposed. Then, the data electrode paste is developed to form a data electrode pattern. Finally, using a firing furnace, the data electrode pattern is fired at a predetermined temperature. That is, the photosensitive resin is removed from the data electrode pattern. In addition, the glass frit of the data electrode pattern is resolved. The resolved glass frit is vitrified after the firing. Through the aforementioned processes, a data electrode 12 is formed. Here, in addition the screen print technique of the data electrode paste, a sputtering technique, a deposition technique, and the like may be used.

Then, insulating layer 13 is formed. As a material of insulating layer 13, an insulating paste containing insulating glass frit, resin, a solvent, and the like is used. First, through a screen print technique and the like, the insulating paste is coated on rear glass substrate 11 having data electrode 12 with a predetermined thickness to cover data electrode 12. Then, using the drying furnace, the solvent of the insulating paste is removed. Finally, using the firing furnace, the insulating paste is fired at a predetermined temperature. That is, the resin is removed from the insulating paste. In addition, the insulating glass frit is resolved. The resolved insulating glass frit is vitrified after the firing. Through the aforementioned processes, the insulating layer 13 is formed. Here, in addition to the screen print technique of the insulating paste, a die coating technique, a spin coat technique, and the like may be used. In addition, without using the insulating paste, a film serving as insulating layer 13 may be formed through a chemical vapor deposition (CVD) technique and the like.

Next, through a photolithographic technique, barrier rib 14 is formed. As a material of barrier rib 14, a barrier rib paste containing a filler, glass frit to bind the filler, photosensitive resin, a solvent, and the like is used. First, through a die coating technique, the barrier rib paste is coated on insulating layer 13 with a predetermined thickness. Then, using the drying furnace, the solution is removed from the barrier rib paste. Then, the barrier rib paste is exposed using a photo mask having a predetermined pattern. Then, the barrier rib paste is developed to form a barrier rib pattern. Finally, using the firing furnace, the barrier rib pattern is fired at a predetermined temperature. That is, the photosensitive resin is removed from the barrier rib pattern. In addition, the glass frit of the barrier rib pattern is resolved. The resolved glass frit is vitrified after the firing. Through the aforementioned processes, barrier rib 14 is formed. Here, in addition to the photolithographic technique, a sand blast technique may be used.

Then, a phosphor layer 15 is formed. As a material of phosphor layer 15, a phosphor paste containing phosphor particles, a binder, a solvent, and the like is used. First, through a dispense technique, the phosphor paste is coated on the side face of barrier rib 14 and on insulating layer 13 between the neighboring barrier ribs 14 with a predetermined thickness. Then, using a drying furnace, the solvent is removed from the phosphor paste. Finally, using the firing furnace, the phosphor paste is fired at a predetermined temperature. That is, the resin is removed from the phosphor paste. Through the aforementioned processes, the phosphor layer 15 is formed. Here, in addition to the dispense technique, a screen print technique may be used.

Through the aforementioned processes, a rear panel having predetermined elements on the rear glass substrate 11 is completed.

4-3. Frit Coating Process B2

Next, glass frit as a sealing member is coated on the area other than an image display area of the rear panel 10 fabricated through rear panel fabricating process B1. Then, in order to remove resin components of the glass frit, frit coating process B2 is carried out to perform pre-baking at a temperature of about 350° C.

Here, as a sealing member, frit containing bismuth oxide or vanadium oxide as a main component is preferably used. The frit containing bismuth oxide as a main component may include, for example, those obtained by adding a filler made of oxides such as Al₂O₃, SiO₂, and cordierite to a Bi₂O₂—B₂O₂—RO-MO based glass material (Here, R is any one of Ba, Sr, Ca, and Mg, and M is any one of Cu, Sb, and Fe). The frit containing vanadium oxide as a main component may include, for example, those obtained by adding a filler made of oxides such as Al₂O₂, SiO₂, and cordierite to a V₂O₅—BaO—TeO-WO based glass material.

4-4. From Sealing Process C1 to Discharge Gas Supply Process C4

Next, front panel 2 and the rear panel 10 subject to frit coating process B1 are arranged to face each other, and the peripheral portions are sealed using a sealing member. Then, the discharge gas is hermetically enclosed in the discharge space.

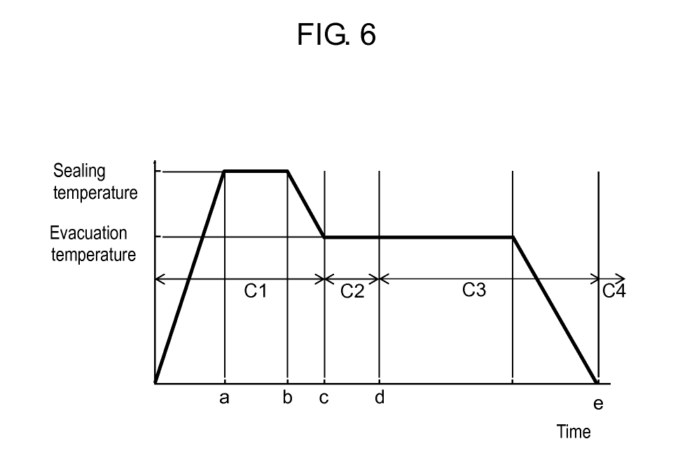

Through sealing process C1, reducing gas introduction process C2, evacuation process C3, and discharge gas supply process C4 according to the present embodiment, processing of a temperature profile shown in FIG. 6, 7, or 8 is carried out for the same device.

In FIGS. 6 to 8, the sealing temperature refers to a temperature at which front panel 2 and rear panel 10 are sealed using the frit as a sealing member. The sealing temperature of the present embodiment is set to, for example, about 490° C. In addition, the evacuation temperature in FIGS. 6 to 8 refers to a temperature at which gases containing the reducing organic gas are exhausted from the discharge space. The evacuation temperature of the present embodiment is set to, for example, about 400° C.

4-4-1. Example of First Temperature Profile

As shown in FIG. 6, first, in sealing process C1, the temperature rises from room temperature to the sealing temperature. Then, the temperature is maintained at the sealing temperature for period a-b. Then, the temperature falls from the sealing temperature to the evacuation temperature for period b-c. For period b-c, the discharge space is evacuated. That is, the discharge space has a depressurized state.

Then, in reducing gas introduction process C2, the temperature is maintained at the evacuation temperature for period c-d. For period c-d, gases containing the reducing organic gas are introduced into the discharge space. Protection layer 9 is exposed to gases containing the reducing organic gas for period c-d.

Then, in evacuation process C3, the temperature is maintained at the evacuation temperature for a predetermined period. Then, the temperature falls to room temperature. For period d-e, the discharge space is evacuated, and thus, gases containing the reducing organic gas are exhausted.

Then, in discharge gas supply process C4, the discharge gas is introduced into the discharge space. That is, the discharge gas is introduced for periods subsequent to e for which the temperature falls to about room temperature.

4-4-2. Example of Second Temperature Profile

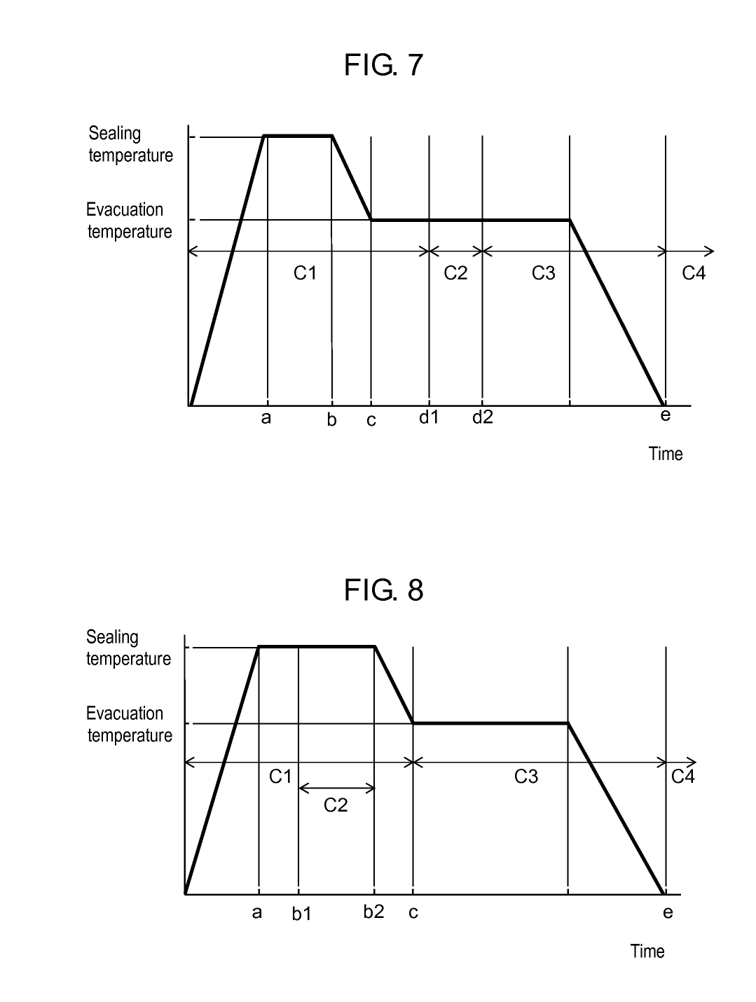

As shown in FIG. 7, first, in sealing process C1, the temperature rises from the room temperature to the sealing temperature. Then, the temperature is maintained at the sealing temperature for period a-b. Then, the temperature falls from the sealing temperature to the evacuation temperature for period b-c. In period c-d1 for which the temperature is maintained at the evacuation temperature, the discharge space is evacuated. That is, the discharge space has a depressurized state.

Then, in reducing gas introduction process C2, the temperature is maintained at the evacuation temperature for period d1-d2. For period d1-d2, gases containing the reducing organic gas are introduced into the discharge space. For period d1-d2, protection layer 9 is exposed to the gases containing the reducing organic gas.

Then, in evacuation process C3, the temperature is maintained at the evacuation temperature for a predetermined period. Then, the temperature falls to the room temperature. In period d2-e, since the discharge space is evacuated, the gases containing the reducing organic gas are exhausted.

Then, in discharge gas supply process C4, the discharge gas is introduced into the discharge space. That is, the discharge gas is introduced for periods subsequent to the period e for which the temperature falls to the room temperature.

4-4-3. Example of Third Temperature Profile

As shown in FIG. 8, first, in sealing process C1, the temperature rises from the room temperature to the sealing temperature. Next, the temperature is maintained at the sealing temperature for period a-b1-b2. The discharge space is evacuated for period a-b1. That is, the discharge space has a depressurized state. Then, the temperature falls from the sealing temperature to the evacuation temperature for a period b2-c.

In the present example, reducing gas introduction process C2 is carried out for the period of sealing process C1. The temperature is maintained at the sealing temperature for period b1-b2. Then, the temperature falls to the evacuation temperature for period b2-c. Gases containing the reducing organic gas are introduced into the discharge space for period b1-c. Protection layer 9 is exposed to the gases containing the reducing organic gas for period b1-c.

Then, in evacuation process C3, the temperature is maintained at the evacuation temperature for a predetermined period. Then, the temperature falls to about the room temperature. For period c-e, since the discharge space is evacuated, the gases containing the reducing organic gas are exhausted.

Then, in discharge gas supply process C4, the discharge gas is introduced into the discharge space. That is, the discharge gas is introduced for a period subsequent to the period e for which the temperature falls to about the room temperature.

Substantially the same effect can be obtained for any temperature profile.

4-4-4. Details of Reducing Organic Gas

As shown in Table 1, as the reducing organic gas, CH based organic gases having a molecular weight equal to or smaller than 58 and a large reducing capacity are preferably used. By mixing at least one selected from various reducing organic gases with rare gases, a nitrogen gas, and the like, the gases containing the reducing organic gas are manufactured.

TABLE 1

| | | | MW | VP | | | |
|---|---|---|---|---|---|---|---|
| | | | (molec- | (vapor | BP | | Reducing |
| Organic | | | ular | pres- | (boiling | Resolv- | Capabil- |
| Gas | C | H | weight) | sure) | point) | ability | ity |
| acetylene | 2 | 2 | 26 | A | A | A | A |
| ethylene | 2 | 4 | 28 | A | A | A | A |
| ethane | 2 | 6 | 30 | A | A | B | A |
| methyl | 3 | 4 | 40 | A | A | A | A |
| acetylene | | | | | | | |
| propadiene | 3 | 4 | 40 | A | A | A | A |
| propylene | 3 | 6 | 42 | A | A | A | A |
| cyclopropane | 3 | 6 | 42 | A | A | A | A |
| propane | 3 | 8 | 44 | A | A | B | A |
| 1-butane | 4 | 6 | 54 | C | C | A | A |
| 1,2- | 4 | 6 | 54 | A | C | A | A |
| butadiene | | | | | | | |
| 1,3- | 4 | 6 | 54 | A | A | A | A |
| butadiene | | | | | | | |
| ethyl | 4 | 6 | 54 | C | C | A | A |
| acetylene | | | | | | | |
| 1-butene | 4 | 8 | 56 | A | A | A | A |
| butane | 4 | 10 | 58 | A | A | B | A |

Referring to Table 1, column C denotes the number of carbon atoms contained in a single molecule of the organic gas. Column H denotes the number of hydrogen atoms contained in a single molecule of the organic gas.

As shown in Table 1, in column VP (vapor pressure), “A” is assigned to the gas having a vapor pressure equal to or higher 100 kPa at a temperature of 0° C., and “C” is assigned to the gas having a vapor pressure lower than 100 kPa at a temperature of 0° C. In column BP (boiling point), “A” is assigned to the gas having a boiling point equal to or lower than 0° C. under a pressure of 1, and “C” is assigned to the gas having a boiling point higher than 0° C. under a pressure of 1. In the column of Resolvability, “A” is assigned to the gas having a high resolvability, and “B” is assigned to common gases having a middle resolvability. In the column of Reducing Capability, “A” is assigned to the gas having a sufficient reducing capability.

In Table 1, “A” means an excellent characteristic, means a middle characteristic, and “C” means an insufficient characteristic.

From the view point of handling easiness of the organic gas during the PDP manufacturing process, a reducing organic gas that can be supplied using a gas reservoir is preferable. In addition, from the viewpoint of handling easiness during the PDP manufacturing process, a reducing organic gas having a vapor pressure equal to or higher than 100 kPa at a temperature of 0° C., a reducing organic gas having a boiling point equal to or lower than 0° C., or a reducing organic gas having a small molecular weight is preferable.

Furthermore, it is likely that a part of the gases containing the reducing organic gas may remain in the discharge space even after evacuation process C3. Therefore, the reducing organic gas preferably has a high resolvability.

As the reducing organic gas, a hydrocarbon-based gas selected from a group consisting of acetylene, ethylene, methyl acetylene, propadiene, propylene, or cyclopropane, without oxygen is preferably used in consideration of handling easiness in the manufacturing process, resolvability, and the like. At least one selected from such reducing organic gases may be mixed with a rare gas or a nitrogen gas.

According to the experimental results obtained by the inventors, for example, when a propylene gas having chemical composition C₂H₆, or a cyclopropane gas is used, the sustain voltage can be lowered by about 10 V. When an acetylene gas having chemical composition C₂H₂ is used, the sustain voltage can be lowered by about 20 V.

The lower limit of the mixing ratio between the rare gas or the nitrogen gas and the reducing organic gas is determined by a combustion ratio of the employed reducing organic gas. The upper limit of the mixing ratio ranges about several volume %. If the mixing ratio of the reducing organic gas is too high, the organic component can be easily polymerized to form polymer. In this case, a part of the polymer remaining in the discharge space affects the characteristics of the PDP. Therefore, the mixing ratio is preferably adjusted depending on the composition of the employed reducing organic gas.

### 5. Details of Protection Layer 9

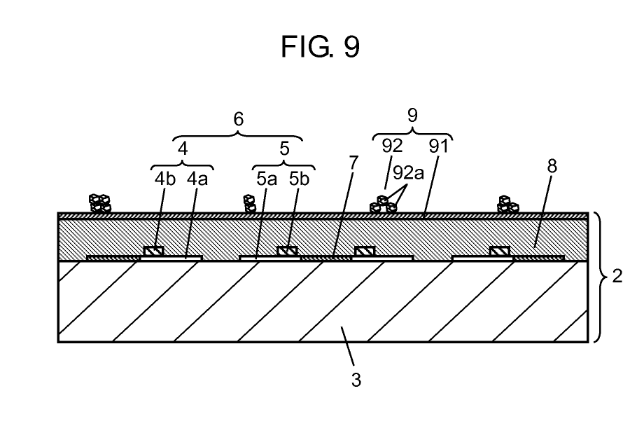

As shown in FIG. 9, protection layer 9 includes base film 91 as a base layer and agglomerated particles 92. Base film 91 may be formed of metal oxides containing at least two oxides selected from a group consisting of MgO, calcium oxide (CaO), strontium oxide (SrO), or barium oxide(BaO). Through an X-ray diffraction analysis for the plane of base film 91, it is recognized that a peak exists between a minimum diffraction angle and a maximum diffraction angle generated by a single body of the oxide contained in metal oxides having a particular azimuth plane.

The agglomerated particles 92 are obtained by agglomerating a plurality of crystal particles 92a of MgO as the metal oxide. Preferably, agglomerated particles 92 are distributed across the entire surface of the base film 91. This will reduce a variation of the discharge voltage in the PDP 1.

In addition, crystal particles 92a of MgO may be manufactured through a gas-phase synthesis technique or a precursor firing technique. According to the gas-phase synthesis technique, first, a metal magnesium material having purity equal to or higher than 99.9% is heated under an atmosphere of an inert gas. In addition, the metal magnesium is directly oxidized by introducing oxygen into the atmosphere. In this manner, crystal particles 92a of MgO are obtained.

According to the precursor firing technique, the precursor of MgO is uniformly fired at a high temperature equal to or higher than 700° C. Then, the precursor is slowly cooled so as to obtain crystal particles 92a of MgO. The precursor may include at least a compound selected from a group consisting of, for example, magnesium alkoxide (Mg(OR)₂), magnesium acetyl acetone(Mg(acac)₂), magnesium hydroxide (Mg(OH)₂), magnesium carbonate (MgCO₂), magnesium chloride (MgCl₂), magnesium sulfate (MgSO₄), magnesium nitrate (Mg (NO₃)₂), and magnesium oxalate (MgC₂O₄). Typically, depending on the selected compound, the precursor may have a hydrate-like composition. Hydrate may be used as the precursor. The compound used as the precursor is adjusted such that the purity of magnesium oxide (MgO) obtained after the firing is equal to or higher than 99.95%, and preferably, 99.98%. If the compound used as the precursor contains a certain amount of impurities such as various alkali metals, B, Si, Fe, and Al, undesired particle adhesion or sintering is generated during heat treatment. As a result, it is difficult to obtain crystal particles of MgO with high crystallinity. Therefore, it is desirable to previously adjust the precursor, for example, by removing impurities from the compound, and the like.

A dispersing liquid is manufactured by dispersing crystal particles 92a of MgO obtained through the some of aforementioned methods into a solvent. Then, the dispersing liquid is coated on the surface of base film 91 using a spraying technique, a screen print technique, an electrostatic coating technique, and the like. Then, the solvent is removed through drying and firing processes. As a result, crystal particles 92a of MgO are fixedly seated on the surface of base film 91.

### 6. Details of Agglomerated Particles 92

In agglomerated particles 92, crystal particles 92a having a predetermined primary particle size are agglomerated or necked. That is, the agglomerated particles are not bonded with a high bonding force as a solid substance, but a plurality of primary particles makes a body of aggregation by means of static electricity or a van der Waals force. Therefore, a part or all of them are bonded in a primary particle state by external stimulus such as ultrasonic waves. The particle diameter of agglomerated particles 92 is set to about 1 μm. Preferably, crystal particles 92a have a polyhedral shape having seven or more faces, such as 14-gonal or dodecahedral.

The particle size of the primary particles of crystal particles 92a can be controlled by the generating condition of crystal particles 92a. For example, in a case where the precursor such as magnesium carbonate or magnesium hydroxide is fired, the particle size can be controlled by controlling the firing temperature or the firing atmosphere. Generally, the firing temperature may be selected from a range between 700° C. and 1500° C. If the firing temperature is set to be a relatively high temperature equal to or higher than 1000° C., the particle size can be controlled to 0.3 to 2 μm. Furthermore, a plurality of primary particles are agglomerated or necked during the creating procedure by heating the precursor so that the agglomerated particles 92 can be obtained.

Through the experiments of the inventors, it was recognized that agglomerated particles 92 obtained by agglomerating a plurality of crystal particles of MgO have an effect of suppressing “discharge delay” in, particularly, address discharge and an effect of improving temperature dependency of the “discharge delay.” Agglomerated particles 92 have an excellent discharge characteristic of initial electrons compared to base film 91. Therefore, according to the present embodiment, agglomerated particles 92 are provided as a supply unit of the initial electrons necessary in initiation of the discharge pulse.

It is envisaged that the “discharge delay” is generated, particularly, due to lack of the amount of initial electrons triggered and discharged into discharge space 16 from the surface of base film 91 at the discharge initiation. In this regard, the agglomerated particles 92 are distributed on the surface of base film 91 in order to help stably supplying the initial electrons to the discharge space 16. As a result, electrons are abundantly present in discharge space 16 at the initiation of the discharge pulse, so that the discharge delay can be addressed. Therefore, due to such a discharge characteristic of the initial electrons, it is possible to implement a high driving speed with an excellent discharge response even when PDP 1 requires high precision. In addition, in the configuration in which agglomerated particles 92 of the metal oxide are provided on the surface of base film 91, it is possible to improve the temperature dependency of the “discharge delay” in addition to suppressing the “discharge delay” particularly in the address discharge.

### 7. Result of Experiments

Next, results of experiments performed to identify characteristics of protection layer 9 according to the present embodiment will be described. Sample 1 is a PDP only having a protection layer made of MgO. Sample 2 is a PDP having a protection layer of MgO onto which impurities Al or Si are doped. Sample 3 is a PDP in which the primary particles of the crystal particles of MgO are distributed on the base film of MgO. The sample 4 is a PDP in which agglomerated particles 92 obtained by a plurality of crystal particles 92a of MgO are uniformly distributed across the entire surface of the base film of MgO. The PDPs of samples 1 to 4 are manufactured using the aforementioned manufacturing method. Particularly, the first temperature profile was used for introducing and exhausting the reducing organic gas. Therefore, samples 1 to 4 are different in only the structure of protection layer 9. The sustain voltages of samples 1 to 4 were lower than the sustain voltage of the existing PDP by 10 V to 20 V.

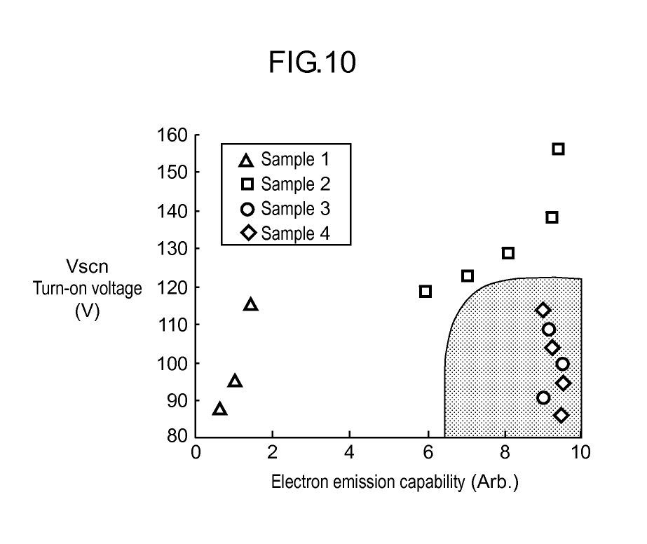

FIG. 10 illustrates electron emission characteristic and charge retention ability. A larger electron emission characteristic indicates a larger electron emission amount. The electron emission characteristic is represented as an initial electron emission amount determined by a surface condition of the discharge, the type of the gas, and the condition thereof. The initial electron emission amount can be measured using a method of irradiating ions or electron beams onto the surface and measuring the electron current amount emitting from the surface. However, it is difficult to carry out the measurement using a nondestructive technique. In this regard, the technique disclosed in Japanese Patent Unexamined Publication No. 2007-48733 was used. Specifically, out of delay times during the discharge, an index, so-called statistic delay time, serving as a reference for indicating easiness of generating discharge, was measured. By integrating the inverse number of the statistic delay time, it is possible to obtain an index linearly proportional to the emission amount of the initial electrons. The delay time of discharge refers to time taken from initiation of the address discharge pulse to the time point at which the discharge is generated with delay. It is envisaged that the discharge delay is generated because the initial electrons triggered when the address discharge is generated is emitted from the surface of the protection layer into the discharge space with difficulty.

The charge retention ability is a voltage applied to the scan electrode necessary to suppress a phenomenon that electric charges are emitted from the protection layer in the PDP (hereinafter, referred to as a Vscn turn-on voltage). As the Vscn turn-on voltage decreases, the electric charge maintaining capability increases. If the Vscn turn-on voltage is low, the PDP can be driven using a low voltage. Therefore, it is possible to use a component with low breakdown voltage and a low capacity in a power supply or various components described above. In existing products, a device with low breakdown voltage of 150 V is used as a semiconductor switching element such as MOSFET for sequentially applying a scan voltage to the panel. The Vscn turn-on voltage is preferably constrained to be equal to or lower than 120 V in consideration of a temperature variation.

Generally, there is a trade-off between a charge retention ability and an electron emission capability of the protection layer. It is possible to improve the electron emission characteristic by changing a formation condition of the protection layer or doping impurities such as Al, Si, and Ba into the protection layer. However, the Vscn turn-on voltage also increases as a side effect.

As apparent from FIG. 10, the electron emission capabilities of the protection layers of samples 3 and 4 are eight or more times that of sample 1. For the charge retention abilities of the protection layers of samples 3 and 4, the Vscn turn-on voltage is equal to or lower than 120 V. Therefore, the PDPs of samples 3 and 4 are further effectively applied to the PDPs having a small cell size while the number of scan lines increases to obtain high precision. That is, in the PDPs of samples 3 and 4, since both the electron emission capability and the charge retention ability are satisfied, it is possible to realize excellent image display using a lower voltage.

### 8. Conclusion

The method of manufacturing PDP 1 disclosed in the present embodiment includes the following processes. Protection layer 9 is exposed to the reducing organic gas by introducing the gases containing the reducing organic gas into the discharge space. Then, the reducing organic gas is exhausted from the discharge space. Then, the discharge gas is hermetically enclosed in the discharge space.

Protection layer 9 exposed to the reducing organic gas suffers from oxygen lacking. It is envisaged that, since the oxygen lacking occurs, a secondary electron emission capability of the protection layer is improved. Therefore, it is possible to reduce the sustain voltage using PDP 1 manufactured through a manufacturing method according to the present embodiment.

The reducing organic gas is preferably a hydrocarbon-based gas without oxygen. Since oxygen is not included, a reducing capability increases.

The reducing organic gas preferably contains at least a material selected from a group consisting of acetylene, ethylene, methyl acetylene, propadiene, propylene, cyclopropane, propane, or butane. The aforementioned reducing organic gases can be easily handled during the manufacturing process. In addition, aforementioned reducing organic gases can be easily resolved.

In the manufacturing method of the present embodiment, the gases containing the reducing organic gas are introduced into the discharge space after the discharge space is evacuated. However, the gases containing the reducing organic gas may be introduced into the discharge space by continuously supplying the gases containing the reducing organic gas into the discharge space without evacuating the discharge space.

Protection layer 9 may include base film 91 as a base layer formed on dielectric layer 8 and crystal particles 92a of a plurality of metal oxides distributed on base film 91.

Protection layer 9 may include base film 91 as a base layer formed on dielectric layer 8 and a plurality of particles distributed on base film 91, wherein the particles may be agglomerated particles 92 obtained by agglomerating crystal particles 92a of a plurality of metal oxides.

If protection layer 9 includes crystal particles 92a of the metal oxide or agglomerated particles 92 obtained by agglomerating a plurality of crystal particles 92a of the metal oxide on base film 91, it is possible to provide a high charge retention ability and a high electron emission capability. Therefore, it is possible to drive entire PDP 1 in a high speed at a low voltage even with high precision. In addition, it is possible to realize a high quality image display performance while the turn-on errors are reduced.

In the foregoing description, an MgO film has been exemplified as a base layer. However, the performance necessary in the base layer is a high sputtering resistance capability for protecting an insulation material from ion bombardment. That is, the base layer requires neither high charge retention ability nor high electron emission characteristic. In the PDP of the prior art, in order to satisfy both the electron emission characteristic and the sputtering resistance capability higher than a certain level, the protection layer containing MgO as a main component was frequently formed. However, in a case where the electron emission characteristic is dominantly controlled by the crystal particles of the metal oxide, it is not necessary that the base film contains MgO. Other materials having an excellent impact resistance such as Al₂O₃ may be used in the base film.

In the present embodiment, MgO has been exemplarily used as the crystal particles of the metal oxide. However, even using other single crystal particles, the same effect can be obtained by employing crystal particles of metal oxides such as Sr, Ca, Ba, and Al having an excellent electron emission characteristic as in MgO.

### INDUSTRIAL APPLICABILITY

As described above, the technique disclosed in the present embodiment is useful for realizing a PDP with a high quality display performance and lower power consumption.

### REFERENCE MARKS IN THE DRAWINGS

1 PDP
2 front panel
3 front glass substrate
4 scan electrode
4a, 5a transparent electrode
4b, 5b metal bus electrode
5 sustain electrode
6 display electrode
7 black stripe
8 dielectric layer
9 protection layer
10 rear panel
11 rear glass substrate
12 data electrode
13 insulating layer
14 barrier rib
15 phosphor layer
16 discharge space
21 image signal processing circuit
22 data electrode drive circuit
23 scan electrode drive circuit
24 sustain electrode drive circuit
25 timing generator circuit
91 base film
92 agglomerated particle
92a crystal particle

1. A method of manufacturing a plasma display panel having a discharge space and a protection layer facing the discharge space, the method comprising:
exposing the protection layer to a reducing organic gas by introducing gases containing the reducing organic gas into the discharge space; then
exhausting the reducing organic gas from the discharge space; and then
hermetically enclosing a discharge gas in the discharge space.

2. The method of claim 1, wherein the reducing organic gas is a hydrocarbon-based gas without oxygen.

3. The method of claim 2, wherein the reducing organic gas contains at least one selected from a group consisting of acetylene, ethylene, methyl acetylene, propadiene, propylene, cyclopropane, propane, and butane.
